(19) United States
(12) Patent Application Publication
(10) Pub. No.: US 2010/0032093 A1
(43) Pub. Date: Feb. 11, 2010

(54) FASTENING ELEMENT AND METHOD OF CURING A BONDING AND FIXING AGENT

(75) Inventor: Frank BRAUN, Gruendau (DE)

Correspondence Address: GREENBLUM & BERNSTEIN, P.L.C., 1950 ROLAND CLARKE PLACE, RESTON, VA, 20191, US

(73) Assignee: NIE WIEDER BOHREN AG, Hanau (DE)

(21) Appl. No.: 12/537,753

(22) Filed: Aug. 7, 2009

(30) Foreign Application Priority Data
Aug. 8, 2008 (DE) 10 2008 037 095.9

(51) Int. Cl. B32B 37/12; A44B 99/00

(52) U.S. Cl. 156/329; 156/327; 156/331.1; 24/304

(57) ABSTRACT

A fastening element for the fixed attachment of an object to a surface. The element comprises a base body which is capable of accommodating an element for holding the object and can be attached to the surface with the aid of a moisture-curable bonding and fixing agent. The base body is capable of acting at least in part as a water reservoir and/or of accommodating a water reservoir therein such that the agent can receive moisture for curing from the water reservoir. An installation system comprising the fastening element and a moisture-curable agent and a method of curing the agent are also disclosed. This Abstract is not intended to define the invention disclosed in the specification, nor intended to limit the scope of the invention in any way.

### CROSS-REFERENCE TO RELATED APPLICATIONS

The present application claims priority under 35 U.S.C. §119 of German Patent Application No. 10 2008 037 095.9, filed Aug. 8, 2008, the disclosure of which is expressly incorporated by reference herein in its entirety.

### BACKGROUND OF THE INVENTION

1. Field of the Invention

The present invention relates to a fastening element for the fixed attachment of objects, such as towel holders, shelves, lamps or the like fixture articles, to a wall, ceiling, floor or the like surface in, for example, rooms fitted with tiles, marble panels or the like wall paneling. The invention furthermore relates to an installation system comprising the combination of the fastening element with a curable bonding and fixing agent and a method of curing the bonding and fixing agent by means of which the fastening element is fastened to the wall, ceiling, floor or the like.

2. Discussion of Background Information

A fastening element of the type discussed herein is known from WO 03/036106, the entire disclosure whereof is expressly incorporated herein by reference. The element comprises a base body that can be attached to the wall with the aid of a curable bonding and fixing agent. Usually the bonding and fixing agent is an adhesive that cures regardless of the surrounding conditions, wherein the adhesives require up to 12 hours and more for curing. It takes a correspondingly long time before the known fastening element can be fully loaded.

In view of the foregoing, it would be desirable to have available a fastening element for the fixed attachment of objects to a wall, ceiling or floor, an installation system comprising the combination of the fastening element with a curable bonding and fixing agent and a method for curing the bonding and fixing agent, with which the fastening element is fastened to the wall, by means of which the setting time of the bonding and fixing agent can be shortened in a simple manner and the full loadability of the fastening element thereby be achieved sooner.

### SUMMARY OF THE INVENTION

The present invention provides a fastening element for the fixed attachment of an object such as a towel holder, a shelf, a lamp or the like fixture article to a surface such as a wall, ceiling, floor or the like in, for example, rooms fitted with tiles, marble panels or the like wall paneling. The fastening element comprises a base body which is capable of accommodating an element for holding the object and can be attached to the surface with the aid of a moisture-curable bonding and fixing agent. The base body is capable of acting at least in part as a water reservoir and/or of accommodating a water reservoir therein such that the bonding and fixing agent can receive moisture for curing from the water reservoir to thereby accelerate the curing of the bonding and fixing agent.

In one aspect of the fastening element, the water reservoir may comprise a mechanical water reservoir that comprises one or more cavities which are capable of holding water and/or the water reservoir may comprise a chemical water reservoir which is capable of holding chemically bonded water and/or the water reservoir may comprise a physical water reservoir which is capable of holding physically bonded water.

In another aspect of the fastening element, the water reservoir may be formed from a material of the base body and/or the water reservoir may comprise a water reservoir insert which can be placed in and/or on the base body.

In yet another aspect, the material of the water reservoir may comprise a composite material that comprises at least one mineral filler and at least one synthetic resin. For example, the composite material may comprise from about 5% to about 85% by weight of the at least one mineral filler and/or the at least one mineral filler may comprise aluminum trihydroxide and/or the at least one synthetic resin may comprise an acrylic resin.

The present invention also provides an installation system for the fixed attachment of an object to a surface. The installation system comprises the fastening element of the present invention as set forth above (including the various aspects thereof) and at least one moisture-curable bonding and fixing agent.

In one aspect of the installation system, the at least one moisture-curable bonding and fixing agent may comprise at least one of an agent based on polyurethane, isocyanate or cyanacrylate, a silicone sealant, and an MS polymer.

The present invention also provides a method of curing a moisture-curable bonding and fixing agent with which a fastening element for the fixed attachment of an object to a surface can be fastened to the surface. The method comprises providing a fastening element which comprises a base body which is capable of accommodating an element for holding the object and supplying the bonding and fixing agent with moisture for curing from a water reservoir that is formed by at least a part of the base body and/or accommodated by the base body.

In one aspect of the method, the bonding and fixing agent may be provided with moisture from a mechanical water reservoir that comprises one or more cavities which are at least partially filled with water and/or the bonding and fixing agent may be provided with moisture from a chemical water reservoir in which chemically bonded water is present and/or the bonding and fixing agent may be provided with moisture from a physical water reservoir in which physically bonded water is present.

In another aspect of the method, the water reservoir may be formed from a material of the base body and/or comprise a water reservoir insert which can be placed in and/or on the base body.

In yet another aspect of the method, the material of the base body or the water reservoir insert may comprise a composite material that comprises at least one mineral filler and at least one synthetic resin, the at least one mineral filler being present in an amount of from about 5% to about 85% by weight.

In as still further aspect of the method, the moisture-curable bonding and fixing agent may comprise at least one of an agent based on polyurethane, isocyanate or cyanacrylate, a silicone sealant, and an MS polymer.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a sectional view of a base body of a first embodiment of the fastening element according to the invention;

FIG. 2 shows a top view of the base body shown in FIG. 1;

FIG. 3 shows a sectional view of a base body of a second embodiment of the fastening element according to the invention; and

FIG. 4 shows a top view of the base body shown in FIG. 3.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention is based on the realization that the bonding and fixing agents used require moisture for curing which they absorb during the curing process. In the prior art the bonding and fixing agent obtains the moisture from the ambient air. The curing thereby takes place more or less slowly depending on the composition of the bonding and fixing agent and the amount of moisture in the ambient air.

It is proposed according to the invention to provide the bonding and fixing agent with a water reservoir that is arranged in and/or on the base body of the fastening element. This advantageously ensures that on the one hand more moisture than merely the moisture in the ambient air is available for the bonding and fixing agent and on the other hand the provision of this additional moisture can be achieved without the use of additional water containers or the like, since the base body of the fastening element present anyway forms the water reservoir, or the water reservoir can be accommodated in and/or on the base body. The bonding and fixing agent absorbs (also) the moisture from the water reservoir and therefore as a rule cures more quickly than is the case in the event of the moisture absorption exclusively from the ambient air.

The water reservoir can be, for example, a mechanical water reservoir that comprises one or more cavities, which are filled with water, formed in the base body. In this type of reservoir, the contact between the bonding and fixing agent and the water contained in the cavities occurs in that a plurality of channels serves to transport the evaporating water from the cavities to the bonding and fixing agent.

Fluid inclusions can also serve as a mechanical water reservoir. This is water that is enclosed in the cavities of the base body during the production thereof.

Alternatively, the water reservoir can be embodied as a chemical water reservoir. In this case, chemically bonded water is present in the material of the base body of the fastening element, which water is taken up by the bonding and fixing agent upon contact with the base body. Chemically bonded water in this context means crystal water as well as water bound by chemical adsorption (chemisorption). The crystal water is incorporated into the chemical structure of the base body. In general, chemisorption is an attachment of fluids, like water, to the surface of solids, which is similar to chemical binding forces. In chemisorption bonds are linked to the surface.

A further alternative lies in embodying the water reservoir as a physical water reservoir. With this variant, physically bonded water is present in the material of the base body of the fastening element, which water is taken up by the bonding and fixing agent upon contact with the base body. Physically bonded water in this context means so-called free water, which is not chemically bonded, but adheres to the surface of the base body via bonding forces, such as van der Waals forces, and can be easily released again (physisorption). This includes, for example, water that adheres to the surface of the base body through ionic forces, water that adheres to the porous surface of the base body through molecular attraction, and water that is held in the capillaries, cracks, pores and the like of the base body through the forces of surface tension.

Surface here means not only the outer surface of the base body, but also the inner surface, which is formed by the capillaries, pores, cracks and the like in the base body. The capillaries, pores, cracks and the like are referred to below for the sake of simplicity as cavities.

A preferred variant of the fastening element is that the entire base body comprises an open-cell material. This increases the surface of the base body and thus renders possible a high water adsorption.

A particularly advantageous effect with respect to shortening the setting time is achieved with a physical water reservoir when the material of the base body is selected from water-absorbing materials, preferably polyamides and synthetic resin compressed wood, more preferably polymer-bonded mineral materials, so-called composite materials, comprising natural mineral fillers and synthetic resins as a matrix, wherein the filler comprises or consists of, for example, aluminum trihydroxide, which usually is contained in the composite material in an amount of from about 5% to about 85% by weight, preferably from about 50% to about 85% by weight, more preferably from about 70% to about 85% by weight, based on the total weight of the composite material, and the synthetic resin comprises or consists of an acrylate polymer, for example, and the bonding and fixing agent comprises or is a moisture-curing or moisture-crosslinking bonding and fixing agent, preferably a bonding and fixing agent based on polyurethane, isocyanate or cyanacrylate, a silicone sealant or MS polymer (polymers on the basis of modified silane), more preferably a silicone sealant. Most preferred is a highly viscous, stable, one-component adhesive based on silane-modified polymers, which crosslinks through atmospheric humidity to form an elastic product.

According to the invention, the water reservoir is formed by at least a partial area of the material of the base body itself and/or the reservoir is present in the form of a water reservoir insert which is separate from the base body, which insert can be placed in and/or on the base body. The water reservoir insert is particularly advantageous when the material compositions forming the chemical or physical water reservoir have properties that do not meet the requirements that the properties of the base body have to satisfy. For example, it may be the case that a specific material composition has optimal properties as a chemical or physical water storage reservoir, but does not guarantee the kind of mechanical strength that is required of the base body of the fastening element with respect to the holding forces required.

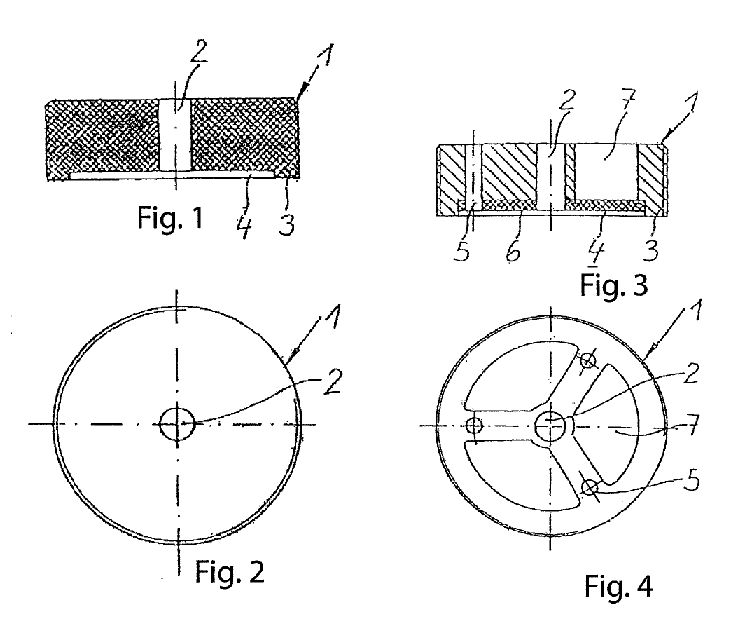

FIGS. 1 and 2 show a first embodiment of the fastening element in accordance with the present invention. It comprises a circular base body 1, which has a central filling opening 2 for filling a curable bonding and fixing agent. In an alternative embodiment, the filling opening may not be arranged centrally and be optimized according to the degree of filling. This bonding and fixing agent reaches the recess 4 arranged in the lower side of the base body 1 in FIG. 1. The base body is attached, preferably adhered, to the wall with the rear 3 of the base body 1 located at the bottom in FIG. 1. On its outer circumference, the base body 1 is provided with a screw thread, on which, for example, the closure elements shown in FIGS. 13-15 of WO 03/036106 A1 can be screwed. The element for accommodating the object to be held on the wall is located on the closure element shown in FIG. 13 of WO 03/036106 A1.

In further embodiments the base body can have other geometric shapes in addition to the circular design and the filling opening can also be provided at a different location of the base body.

Non-limiting examples of further alternative embodiments of the fastening element, which deviate from the exemplary embodiment described above, include:
(i) A fastening element with one or more bolts pressed into the base body: with this type, either bolts with an external thread or smooth bolts are pressed into bores of the base body, which bolts serve to accommodate the parts/accessories to be attached.
(ii) A fastening element with one or more inserts pressed into the base body: with this type, one or more inserts with an internal thread are pressed into bores of the base body, which inserts serve to accommodate the parts/accessories to be attached.
(iii) A fastening element with mounting rings: with this type, one or more mounting rings of Zamak (zinc/aluminum/magnesium alloy) are riveted onto the base body (e.g. sintered-metal disk).
(iv) A fastening element with an internal thread: with this type, the thread is cut directly into the base body.

With the first embodiment, the material of the entire base body 1 forms a physical water reservoir in which physically bonded water is present. The material of the base body 1 comprises the water-absorbent materials described above. These materials have a particularly advantageous effect with the bonding and fixing agents described above.

FIGS. 3 and 4 show a second embodiment of the fastening element according to the present invention. As with the first embodiment, the circular base body 1 of the second embodiment also has a central filling opening 2 for filling the bonding and fixing agent.

In contrast to the first embodiment, however, in this case the material of the entire base body 1 does not form the water reservoir as defined by the present invention. Instead, in this case a circular disk-shaped water reservoir insert 6 is provided, which is placed in the recess 4, which is located on the rear 3 of the base body 1 at the bottom in FIG. 3. A part of the recess 4 is thus filled by the water reservoir insert 6, while the bonding and fixing agent that can enter through the filling opening 2 can reach the remaining part of the recess 4. The material of the separate water reservoir insert 6 forms a physical water reservoir in which physically bonded water is present.

In a manner known per se excess bonding and fixing agent can flow off through three vent openings 5 in the embodiment shown. Furthermore, likewise in a manner known per se three apertures 7 are provided in the base body 1, through which gases produced during the curing of the bonding and fixing agent can exit in that the water reservoir insert 6 is permeable to them. In an alternative embodiment, a vent opening may be provided with a filling opening that is not arranged centrally. Also, only one aperture 7 may be provided in the base body 1.

The material of the base body 1 and of the water reservoir insert 6 comprises the water-absorbing materials mentioned at the outset, which interact with the silicone sealant acting as a bonding and fixing agent in a particularly advantageous manner with respect to the greatest possible reduction of the setting period. The composite material sold by DuPont AG under the trade name CORIAN® (acrylic resin with 67% aluminum trihydroxide; modulus of elasticity: 10 GPa; bending strength: 90 MPa), and the composite material sold by Spektra, a company owned by Keramag AG, under the trade name VARICOR® (acrylic resin with 68% aluminum trihydroxide; modulus of elasticity: 10 GPa; bending strength: 50 MPa), are non-limiting examples of composite materials that may be used. The silicone sealant sold by Henkel KGaA under the trade name Terostat®-MS 9380 is a non-limiting example of a bonding and fixing agent.

Various mechanisms are conceivable for how water is released from the base body 1 or from the water reservoir insert 6 and supplied to the bonding and fixing agent for the curing thereof. These are, for example, the processes generally combined under the heading sorption and known to one skilled in the art. Without wanting to be bound by any theory, some of the theoretically conceivable mechanisms are presented below by way of example.

The chemically bonded water in the base body 1 or the water reservoir insert 6 can be cleaved from the base body by chemical reaction with a component from the bonding and fixing agent. This leads to a partial destruction of the base body 1 or of the water reservoir insert 6. If the base body comprises the materials Corian® or Varicor®, which contain aluminum trihydroxide, for example, a chemical reaction of the aluminum trihydroxide is conceivable in which water is released. Aluminum trihydroxide can react with protonic acids, for example, wherein water and ionic aluminum compounds are produced. When a bonding and fixing agent is used which releases protonic acids during curing, the protonic acid can react with the aluminum trihydroxide, whereby water is formed, which in turn is available for curing the bonding and fixing agent. For example, acetic acid, which is released from bonding and fixing agents in the form of acetate systems, can be used as a protonic acid. The water necessary for the initial curing reaction is provided, for example, by the water bonded by physisorption on the surface of the base body 1 or the water reservoir insert 6.

In the embodiment shown in FIGS. 3 and 4, in the base body 1 exactly one cut-out is provided in which the water reservoir insert 6 can be accommodated such that the bonding and fixing agent can obtain moisture for curing from the water reservoir. Alternatively, it is conceivable to form several (e.g., two, three, four, five, etc.) smaller cut-outs in the rear 3 of the base body 1 to accommodate respectively one disc-shaped, rectangular or cubic water reservoir insert 6. The several chemical water reservoir inserts 6 thereby comprise a material that can react with the compounds, such as, for example, acetic acid, alcohols and the like, released during the curing of the water-curable bonding and fixing agent, thereby releasing water. The water produced thereby is available for further curing of the bonding and fixing agent, as already described in the previous paragraph. A corresponding material can also be selected, of course, if only a single water reservoir insert 6 is provided.

If the base body 1 or the water reservoir insert 6 is a physical water reservoir, the water necessary for curing of the boding and fixing agent is provided through desorption of the physically bonded water in the cavities of the base body. In the cavities an equilibrium is established between the adsorbed water and the desorbed water which is present in the cavities in vapor form. If the water molecules on the contact surface between the base body 1 or the water reservoir insert 6 and the bonding and fixing agent are consumed through the reaction with the bonding and fixing agent this process interferes with the equilibrium in the cavities of the base body. Through desorption, water molecules pass into the vapor phase again, until the equilibrium is restored. Water molecules for the curing of the bonding and fixing agent are thus available again on the contact surface between the base body 1 or the water reservoir insert 6 and the bonding and fixing agent.

Not only the water molecules in the vapor phase are available for curing the bonding and fixing agent, but also the water molecules that are still adsorbed. Since the water molecules are held on the surface of the base body only through interactions, the adsorbed water molecules do not have a fixed bonding location on the surface, do not stay at the location where they were adsorbed, but move freely along the surface. This is called mobility. This mobility makes it possible to replenish the water molecules that are consumed on the contact surface between the base body 1 or the water reservoir insert 6 and the bonding and fixing agent. Further water molecules are thus available for the curing reaction of the bonding and fixing agent on the contact surface between the base body 1 or the water reservoir insert 6 and the bonding and fixing agent.

Because during chemisorption the adsorbed water can usually move along the surface despite a chemical bond to the surface of the base body, a water transport to the contact surface between the base body 1 or the reservoir insert 6 and the bonding and fixing agent is possible during chemisorption like in the case of physisorption.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

### LIST OF REFERENCE NUMERALS

1 Base body
2 Filling opening
3 Rear of the base body
4 Recess
5 Vent opening
6 Water reservoir insert
7 Aperture

What is claimed is:

1. A fastening element for the fixed attachment of an object to a surface, wherein the fastening element comprises a base body which is capable of accommodating an element for holding the object and can be attached to the surface with the aid of a moisture-curable bonding and fixing agent, the base body being capable of at least one of acting at least in part as a water reservoir and of accommodating a water reservoir therein such that the bonding and fixing agent can receive moisture for curing from the water reservoir.

2. The fastening element of claim 1, wherein the water reservoir comprises a mechanical water reservoir comprising one or more cavities which are capable of holding water.

3. The fastening element of claim 1, wherein the water reservoir comprises a chemical water reservoir which is capable of holding chemically bonded water.

4. The fastening element of claim 1, wherein the water reservoir comprises a physical water reservoir which is capable of holding physically bonded water.

5. The fastening element of claim 1, wherein the water reservoir is formed from a material of the base body.

6. The fastening element of claim 1, wherein the water reservoir comprises a water reservoir insert which can be placed at least one of in and on the base body.

7. The fastening element of claim 1, wherein a material of the water reservoir comprises a composite material comprising at least one mineral filler and at least one synthetic resin.

8. The fastening element of claim 7, wherein the composite material comprises from about 5% to about 85% by weight of the at least one mineral filler.

9. The fastening element of claim 7, wherein the at least one mineral filler comprises aluminum trihydroxide and the at least one synthetic resin comprises an acrylic resin.

10. An installation system for the fixed attachment of an object to a surface, wherein the installation system comprises the fastening element of claim 1 and at least one moisture-curable bonding and fixing agent.

11. The installation system of claim 10, wherein the at least one moisture-curable bonding and fixing agent comprises at least one of an agent based on polyurethane, isocyanate or cyanacrylate, a silicone sealant, and an MS polymer.

12. The installation system of claim 10, wherein the at least one moisture-curable bonding and fixing agent comprises a silicone sealant.

13. The installation system of claim 10, wherein a material of the water reservoir comprises a composite material comprising at least one mineral filler and at least one synthetic resin.

14. A method of curing a moisture-curable bonding and fixing agent with which a fastening element for the fixed attachment of an object to a surface can be fastened to the surface, wherein the method comprises providing a fastening element which comprises a base body which is capable of accommodating an element for holding the object, and supplying the bonding and fixing agent with moisture for curing from a water reservoir that is at least one of formed by at least a part of the base body and accommodated by the base body.

15. The method of claim 14, wherein the bonding and fixing agent is provided with moisture from a mechanical water reservoir that comprises one or more cavities which are at least partially filled with water.

16. The method of claim 14, wherein the bonding and fixing agent is provided with moisture from a chemical water reservoir in which chemically bonded water is present.

17. The method of claim 14, wherein the bonding and fixing agent is provided with moisture from a physical water reservoir in which physically bonded water is present.

18. The method of claim 14, wherein the water reservoir is at least one of formed from a material of the base body and comprises a water reservoir insert which can be placed at least one of in and on the base body.

19. The method of claim 18, wherein a material of the base body or the water reservoir insert comprises a composite material comprising at least one mineral filler and at least one synthetic resin, the at least one mineral filler being present in an amount of from about 5% to about 85% by weight.

20. The method of claim 14, wherein the moisture-curable bonding and fixing agent comprises at least one of an agent based on polyurethane, isocyanate or cyanacrylate, a silicone sealant, and an MS polymer.
